(19) United States
(12) Patent Application Publication
(10) Pub. No.: US 2025/0258386 A1
(43) Pub. Date: Aug. 14, 2025

(54) PARAMETER DETERMINATION SYSTEM AND PARAMETER DETERMINATION METHOD THEREOF

(71) Applicants: SAMSUNG DISPLAY CO., LTD., YONGIN-SI, GYEONGGI-DO (KR); Sookmyung Women's university industry-academic cooperation foundation, Seoul (KR)

(72) Inventors: Young Sang HA, Yongin-si, Gyeonggi-do (KR); Young Ju JEONG, Seoul (KR); Beom Shik KIM, Yongin-si, Gyeonggi-do (KR); Young Chan KIM, Yongin-si, Gyeonggi-do (KR); Hyun Jin CHO, Yongin-si, Gyeonggi-do (KR)

(21) Appl. No.: 18/959,774

(22) Filed: Nov. 26, 2024

(30) Foreign Application Priority Data
Feb. 13, 2024 (KR) 10-2024-0020591

(51) Int. Cl. G02B 30/28

(52) U.S. Cl. CPC G02B 30/28

(57) ABSTRACT

A parameter determination system includes an optical panel including a plurality of variable lenses. A display panel is positioned to overlap with the optical panel and is spaced apart from the display panel by a lens-panel gap. The display panel includes a plurality of sub-pixels. A panel viewing distance controller adjusts a viewing distance between the optical panel and an imaging device capturing the optical panel. A controller outputs a signal for adjusting at least one of a size of a lens width of the plurality of variable lenses and a distance of the lens-panel gap, based on images of the display panel captured by the imaging device at different viewing distances.

This application claims priority under 35 U.S.C. § 119 to Korean Patent Application No. 10-2024-0020591, filed on Feb. 13, 2024 in the Korean Intellectual Property Office, the present disclosure of which is incorporated by reference in its entirety herein.

### 1. TECHNICAL FIELD

Embodiments of the present disclosure relate to a parameter determination system and a parameter determination method thereof.

### 2. DISCUSSION OF RELATED ART

A display device is an electronic device that serves as a connection medium providing images to a user. The importance of display devices has increased along with the development of information technology. For example, the usage of display devices such as a liquid crystal display device (LCD) and an organic light emitting display device is increasing.

The display device may provide a stereoscopic effect to the user by stimulating a viewer's visual sense identically, or similarly, to an actual object. An image that may provide the stereoscopic effect to the user may be referred to as a stereoscopic image (e.g., a 3D image).

The display device may provide a physical factor so that an image output from a flat display device is recognized as a stereoscopic image by the user. For example, the display device may provide different images to a left eye and a right eye of the user of the display device. The user may feel the stereoscopic effect of the image due to a binocular parallax between the left eye and the right eye.

Recently, research is being conducted with respect to a method in which the user may watch the stereoscopic image without wearing stereoscopic glasses (e.g., a glasses-free method). The glasses-free method includes a lenticular method in which images of a left eye and a right eye are separated using a cylindrical lens array, and a barrier method in which images of a left eye and a right eye are separated using a barrier.

### SUMMARY

A technical object to be solved is to provide a parameter determination system and a parameter determination method thereof that may reduce or prevent recognition of moire.

According to an embodiment of the present disclosure, a parameter determination system includes an optical panel including a plurality of variable lenses. A display panel is positioned to overlap with the optical panel and is spaced apart from the optical panel by a lens-panel gap. The display panel includes a plurality of sub-pixels. A panel viewing distance controller adjusts a viewing distance between the optical panel and an imaging device capturing the optical panel. A controller outputs a signal for adjusting at least one of a size of a lens width of the plurality of variable lenses and a distance of the lens-panel gap, based on images of the optical panel captured by the imaging device at different viewing distances.

In an embodiment, the controller may output the signal so that a number of moires detected in the images is decreased.

In an embodiment, the optical panel may further include a base substrate supporting the plurality of variable lenses, a first magnet unit positioned inside the plurality of variable lenses, and a second magnet unit positioned on the base substrate.

In an embodiment, at least one of the first magnet unit and the second magnet unit may be an electromagnet, and the controller may output an electromagnet control signal for imparting magnetism to the at least one of the first magnet unit and the second magnet unit or removing magnetism from the at least one of the first magnet unit and the second magnet unit.

In an embodiment, a width of each of the plurality of variable lenses may be controlled based on the electromagnet control signal.

In an embodiment, the panel viewing distance controller may the imaging device comprising a camera, a first vertical support extending in a vertical direction from a ground, and a first horizontal support extending from the first vertical support in a horizontal direction on the optical panel, the camera is mounted on the first horizontal support. The first horizontal support may move in the vertical direction along the first vertical support.

In an embodiment, the first vertical support may further include a first rail guiding a movement of the first horizontal support in the vertical direction.

In an embodiment, the parameter determination system may further include a lens-panel gap controller controlling a distance of the lens-panel gap between the optical panel and the display panel.

In an embodiment, the lens-panel gap controller may include a second vertical support extending in a vertical direction from a ground, and a second horizontal support extending from the second vertical support in a horizontal direction. The display panel is attached to the second horizontal support. The second horizontal support may move in the vertical direction along the second vertical support.

In an embodiment, the second vertical support may further include a second rail guiding a movement of the second horizontal support in the vertical direction.

In an embodiment, the controller may compare a first number comprising a number of moires detected in an image captured at a first viewing distance with a second number comprising a number of moires detected in an image captured at a second viewing distance farther than the first viewing distance, and the controller outputs a signal for adjusting at least one of a size of the lens width and a distance of the lens-panel gap based on a comparison result of the first number with the second number.

In an embodiment, the controller may detect the number of moires in the image captured at the first viewing distance, and detect the number of moires in the image captured at the second viewing distance farther than the first viewing distance.

In an embodiment, when the first number is less than the second number, the controller may decrease the size of the lens width, and when the first number is greater than the second number, the controller may increase the size of the lens width.

In an embodiment, when the first number is less than the second number, the controller may decrease the distance of the lens-panel gap, and when the first number is greater than the second number, the controller may increase the distance of the lens-panel gap.

In an embodiment, the controller may provide at least one of a size of the lens width and a size of the lens-panel gap as a parameter when both of the first number and the second number are 0.

According to an embodiment of the present disclosure, a parameter determination method includes capturing an optical panel that includes a plurality of variable lenses at a first viewing distance by a camera of a panel viewing distance controller. The optical panel is spaced apart from a display panel by a lens-panel gap of a predetermined distance. A first number is obtained that is a number of moires in an image of the optical panel captured by the camera at the first viewing distance. The optical panel is captured by the camera at a second viewing distance that is less than the first viewing distance. A second number is obtained that is a number of moires in an image of the optical panel captured by the camera at the second viewing distance. A signal is output for adjusting at least one of a size of a lens width of the plurality of variable lenses and a distance of the lens-panel gap so that a number of moires is decreased based on a result of comparing the first number and the second number by a controller.

In an embodiment, when the first number is less than the second number, the controller may decrease the size of the lens width, and when the first number is greater than the second number, the controller may increase the size of the lens width.

In an embodiment, the controller may provide the size of the lens width as a parameter when both of the first number and the second number are 0.

In an embodiment, when the first number is less than the second number, the controller may decrease the distance of the lens-panel gap, and when the first number is greater than the second number, the controller may increase the distance of the lens-panel gap.

In an embodiment, the controller may provide the distance of the lens-panel gap as a parameter when both of the first number and the second number are 0.

### BRIEF DESCRIPTION OF THE DRAWINGS

The above and other features of the present disclosure will become more apparent by describing in further detail non-limiting embodiments thereof with reference to the accompanying drawings, in which:

FIG. 1 is a conceptual diagram of a display device according to an embodiment of the present disclosure;

FIG. 2 is a diagram illustrating display of a stereoscopic image from a viewpoint by the display device of FIG. 1 according to an embodiment of the present disclosure;

FIG. 3 is a flowchart of a parameter determination method according to an embodiment of the present disclosure;

FIG. 4A is an example of an image in which more moire is detected;

FIG. 4B is an example of an image in which less moire is detected;

FIGS. 5 and 6 are parameter determination systems according to embodiments of the present disclosure;

FIGS. 7A and 7B are diagrams illustrating embodiments in which a width of a plurality of variable lenses are adjusted in an optical panel;

FIG. 8 is a diagram illustrating a controller transmitting an electromagnet control signal to the optical panel;

FIG. 9 is a flowchart of a parameter determination method according to an embodiment of the present disclosure;

FIG. 10A is an example of an image in which more moire is detected;

FIG. 10B is an example of an image in which less moire is detected;

FIGS. 11 and 12 are parameter determination systems according to embodiments of the present disclosure; and

FIGS. 13 to 15 are diagrams conceptually illustrating that an area from which light is emitted varies according to a lens-panel gap and a thickness of a lens according to embodiments of the present disclosure.

### DETAILED DESCRIPTION OF EMBODIMENTS

Hereinafter, various embodiments of the present disclosure will be described in detail with reference to the accompanying drawings so that those skilled in the art may easily carry out the present disclosure. Embodiments of the present disclosure may be implemented in various different forms and is not limited to embodiments described herein.

To clearly describe embodiments of the present disclosure, parts that are not related to the description may be omitted, and the same or similar elements are denoted by the same reference numerals throughout the specification. Therefore, the above-described reference numerals may be used in other drawings.

In addition, sizes and thicknesses of each component shown in the drawings may be arbitrarily shown for convenience of description, and thus embodiments of the present disclosure are not necessarily limited to those shown in the drawings. In the drawings, thicknesses may be exaggerated to clearly express various layers and areas.

In addition, an expression “is the same” in the description may mean “is substantially the same”. Other expressions may also be expressions in which “substantially” is omitted.

Terms of “first”, “second”, and the like may be used to describe various components, but the components should not necessarily be limited by the terms. The terms may be used only for the purpose of distinguishing one component from another component. For example, without departing from the scope of embodiments of the present disclosure, a first component may be referred to as a second component, and similarly, a second component may also be referred to as a first component. The singular expressions include plural expressions unless the context clearly indicates otherwise.

Terms of “under”, “below”, “on”, and “above” are used to describe an association of configurations shown in the drawings. The terms are described based on a direction indicated in the drawings as relative concepts.

Unless defined otherwise, all terms (including technical terms and scientific terms) used herein have the same meaning as a meaning generally understood by one of ordinary skill in the art to which embodiments of the present disclosure belongs. In addition, terms such as those defined in a generally used dictionary are to be interpreted as having a meaning consistent with a meaning in a context of the related art, unless explicitly defined herein, and should not be interpreted in an overly formal meaning.

It should be understood that a term of “include”, “have”, or the like is used to specify that there is a feature, a number, a step, an operation, a component, a part, or a combination thereof described in the specification, but does not exclude a possibility of the presence or addition of one or more other features, numbers, steps, operations, components, parts, or combinations thereof in advance.

Hereinafter, embodiments of the present disclosure are described in detail with reference to the accompanying drawings.

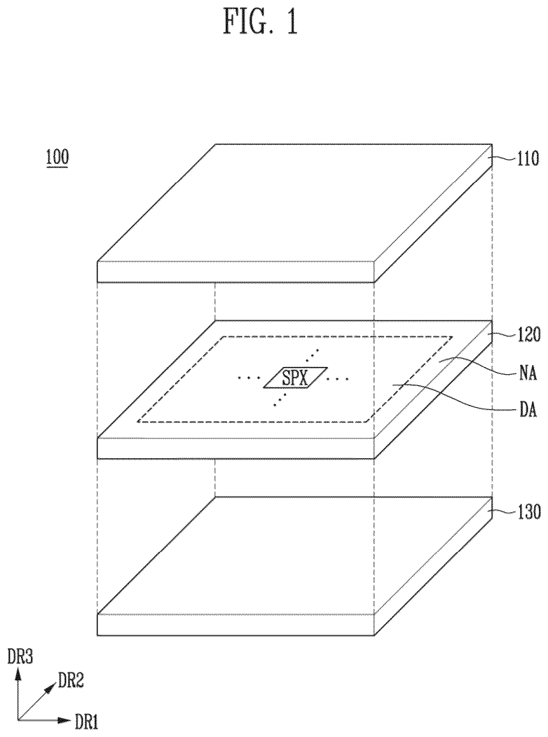

FIG. 1 is a conceptual diagram of a display device 100 according to an embodiment of the present disclosure.

The display device 100 according to an embodiment of the present disclosure may include an optical panel 110, a display panel 120, a back cover 130, and the like.

The optical panel 110 may be configured to adjust an intensity and a direction of light emitted from the display panel 120. In an embodiment, the optical panel 110 may include one or more lenses, and a user of the display device 100 may recognize an image emitted from the display panel 120 as a stereoscopic image.

The display panel 120 may include a display area DA and a non-display area NA positioned around the display area DA (for example, an edge area of the display area DA in the first and/or second directions DR1, DR2). The display area DA may extend in a first direction DR1 and a second direction DR2 that intersects the first direction DR1. The display panel 120 may include a plurality of sub-pixels SPX. Each of the plurality of sub-pixels SPX may emit light of a predetermined wavelength band. The plurality of sub-pixels SPX may be arranged in the display area DA. For example, the plurality of sub-pixels SPX arranged along the first direction DR1 may form a pixel row. For example, the plurality of sub-pixels SPX arranged along the second direction DR2 may form a pixel column.

The display panel 120 according to an embodiment of the present disclosure may generate light and include a light emitting layer configured to emit the generated light. For example, in an embodiment the light emitting layer may include an organic light emitting layer, a quantum dot light emitting layer, an inorganic light emitting layer, or the like. According to a type of the light emitting layer included in the display panel 120, the display device 100 may be implemented as a self-emission display device, such as an organic light emitting display device, a quantum dot display device, or an inorganic light emitting display device.

The display panel 120 according to an embodiment of the present disclosure may not directly generate light and may be configured to selectively emit light incident from an outside. For example, the display device 100 according to an embodiment of the present disclosure may include a light source (e.g., a backlight unit or the like) external to the display panel 120. For example, the display panel 120 may include a liquid crystal configured to adjust an amount of light emitted from the display panel 120. The display panel 120 may adjust the amount of light emitted from the display panel 120 by adjusting a tilting angle or the like of the liquid crystal. In an embodiment in which the display panel 120 does not include a light emitting layer, the display device 100 may be implemented as a light receiving and emitting display device, such as a liquid crystal display.

Below, for convenience of description, the display panel 120 according to an embodiment of the present disclosure is described as a self-emission display device. However, embodiments of the present disclosure are not necessarily limited thereto.

The sub-pixel SPX may include a light emitting element and a pixel circuit for driving the light emitting element. For example, in an embodiment, the pixel circuit may include at least two transistors and at least one capacitor.

In an embodiment, the display panel 120 may include a substrate, a thin film transistor layer on which the pixel circuit is formed, and the light emitting element layer on which a light emitting element is positioned. In an embodiment, the substrate may include a glass substrate, an organic/inorganic composite material substrate, or the like. The substrate may support the thin film transistor layer and the light emitting element layer.

A panel driving circuit for supplying various signals and/or voltages for driving the sub-pixel SPX may be further connected to the display panel 120. The panel driving circuit may be connected (e.g., electrically connected) to a pad unit provided in the non-display area of the display panel 120 to supply the signal, the voltage, and the like to the display panel 120.

The back cover 130 may be positioned on a back surface of the display panel 120. In an embodiment, the panel driving circuit connected to the display panel 120 may be received in the back cover 130. According to an embodiment, at least a portion of the panel driving circuit may be bent to the back surface of the display panel 120 and the panel driving circuit may then be received in the back cover 130. However, embodiments of the present disclosure are not necessarily limited thereto. For example, in an embodiment, the back cover 130 may be omitted.

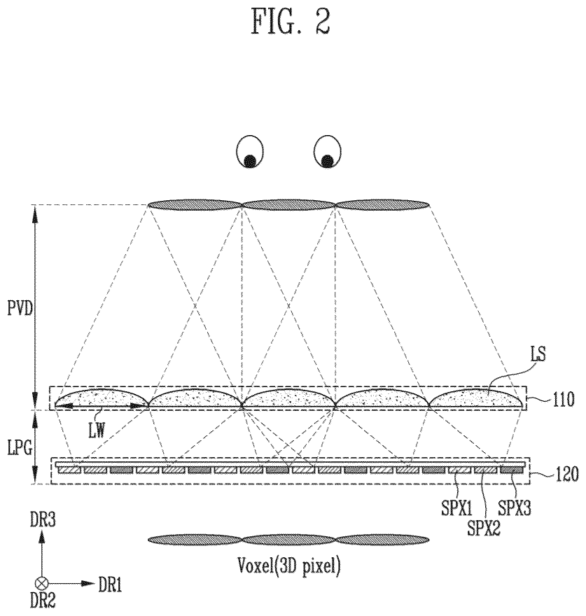

FIG. 2 is a diagram illustrating display of a stereoscopic image from a viewpoint by the display device 100 of FIG. 1 according to an embodiment of the present disclosure.

In an embodiment, the display panel 120 may include a plurality of sub-pixels SPX1, SPX2, and SPX3 that emit light to display an image. In an embodiment, each of the plurality of sub-pixels SPX1, SPX2, and SPX3 may output one of light of a first wavelength band (e.g., a red wavelength band), light of a second wavelength band (e.g., a green wavelength band), and light of a third wavelength band (e.g., a blue wavelength band). The red wavelength band may be a wavelength band of approximately 630 nm (nanometer) to 750 nm. The green wavelength band may be a wavelength band of approximately 495 nm to 570 nm. The blue wavelength band may be a wavelength band of approximately 450 nm to 495 nm. However, embodiments of the present disclosure are not necessarily limited thereto and the wavelength bands of light emitted from the plurality of sub-pixels SPX1, SPX2, and SPX3 may vary, and light of various colors for full-color implementation may be output. The plurality of sub-pixels SPX1, SPX2, and SPX3 that emit light of different wavelength bands may configure one pixel.

The optical panel 110 may be disposed on the display panel 120 (e.g., in a third direction DR3) from the display panel 120. For example, the display panel 120 may overlap with the optical panel 110 and be spaced apart from the optical panel 110 by a predetermined lens-panel gap LPG (e.g., in the third direction DR3). In an embodiment, the optical panel 110 may include a plurality of variable lenses LS configured to refract light incident from the plurality of sub-pixels SPX1, SPX2, and SPX3. The plurality of variable lenses LS may configure a lens array. In an embodiment, the lens array may be implemented as, for example, a lenticular lens array, a micro lens array, or the like. The plurality of variable lenses LS may be disposed to extend in the second direction DR2 in the optical panel 110.

The display device 100 (refer to FIG. 1) according to an embodiment of the present disclosure may be implemented as a light field display device. The light field display is a three-dimensional (3D) display device implementing a stereoscopic image by forming a light field expressed as a vector distribution (e.g., intensity and direction) of light in a space using a flat display, such as the display panel 120, and an optical element, such as the lens array of the optical panel 110. The light field display is a display technology that is expected to be utilized variously through convergence with augmented reality (AR) technology or the like since the light field display allows a depth, a side surface, and the like of an object to be seen and enabling a more natural stereoscopic image.

A light field may be implemented in various methods. For example, in some embodiments, the light field may be formed in a method of creating the light field in a plurality of directions using a plurality of projectors, a method of controlling a direction of light using a diffraction grating, a method of adjusting a direction and an intensity (e.g., luminance) of light according to a combination of the plurality of sub-pixels SPX1, SPX2, and SPX3 using two or more display panels, a method of controlling a direction of light using a pinhole or a barrier, a method of controlling a refraction direction of light through a lens array, or the like.

In an embodiment, as shown in FIG. 2, the lens array type of display device 100 (refer to FIG. 1) may display a stereoscopic image (e.g., a three-dimensional image) by forming the light field.

One or more sub-pixels SPX may be allocated to the variable lens LS of the optical panel 110. Light emitted from the sub-pixel SPX may be refracted by the variable lens LS and may proceed in a specific direction, and thus the light field expressed by the intensity and the direction of the light may be formed. When a user of the display device looks at the display device (e.g., the display panel 120) in the light field formed as described above, the user may feel a stereoscopic effect of the corresponding image.

Image information according to a viewer's viewpoint in the light field may be defined and processed in a voxel unit. A voxel may be understood as graphic information that defines a predetermined point (e.g., a pixel) in a three-dimensional space. A resolution of a two-dimensional image may be determined by the number (e.g., density) of pixels or sub-pixels SPX for the same area. For example, when the number of pixels or sub-pixels SPX increases with respect to the same area, the resolution may increase. For example, to display a high-resolution image, the display panel 120 with a high pixel density may be required. Similarly, as the number of voxels at the same viewpoint through the optical panel 110 increases, the resolution of the stereoscopic image may increase.

In the optical panel 110, the plurality of variable lenses LS may extend in one direction (e.g., the second direction DR2). Accordingly, the user of the display device 100 (refer to FIG. 1) at a viewpoint shown in FIG. 2 may feel the stereoscopic effect of the image.

In an embodiment, the user may view the optical panel 110 at various distances. Referring to FIG. 2, a distance between the user and the optical panel 110 may be indicated as a panel viewing distance PVD. Even though the panel viewing distance PVD varies, it is desirable for the user to recognize a natural stereoscopic image. Therefore, it may be advantageous that moire (e.g., one or more moire patterns) is recognized as little as possible (e.g., minimally or not at all).

The number of moires recognized by the user may vary according to at least the following two parameters. First, the number of moires recognized by the user may be affected by the lens-panel gap LPG, which is a distance between the display panel 120 and the optical panel 110 (e.g., in the third direction DR3). Second, the number of moires recognized by the user may be affected by a width LW of the variable lens LS in the optical panel 110.

Embodiments of the present disclosure may provide a parameter determination system and a parameter determination method thereof for providing a parameter value in which the recognition of moire is reduced or prevented at various panel viewing distances PVD.

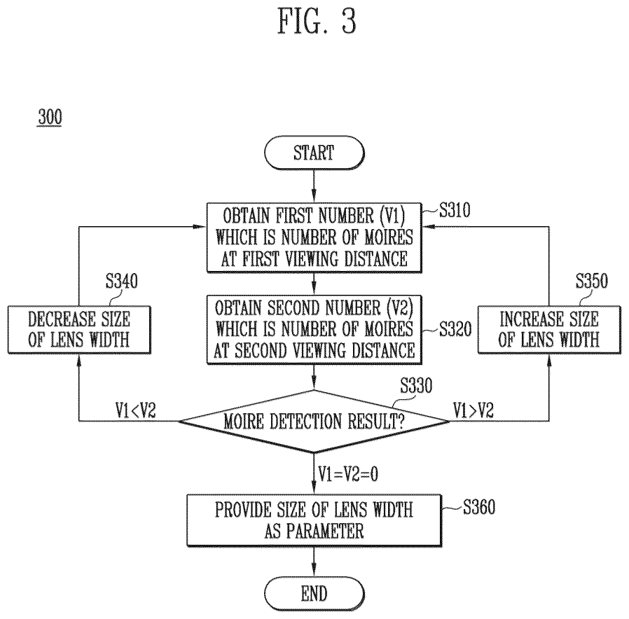

FIG. 3 is an embodiment of a flowchart of a parameter determination method 300 according to an embodiment of the present disclosure.

Referring to FIG. 3, the parameter determination method 300 according to an embodiment of the present disclosure may include obtaining the first number V1, which is the number of moires at a first viewing distance in block S310, obtaining the second number V2, which is the number of moires at a second viewing distance in block S320, determining a moire detection result in block S330, decreasing a size of a lens width in block S340, increasing the size of the lens width in block S350, and providing (e.g., outputting) the size of the lens width as a parameter in block S360.

In an embodiment, in obtaining the first number V1, which is the number of moires at the first viewing distance in block S310, the panel viewing distance PVD (refer to FIG. 2) may be the first viewing distance. The first number V1 may be an integer greater than or equal to 0.

In obtaining the second number V2, which is the number of moires at the second viewing distance in block S320, the panel viewing distance PVD (refer to FIG. 2) may be the second viewing distance. In an embodiment, the second viewing distance may be farther than the first viewing distance. The second number V2 may be an integer greater than or equal to 0.

In determining the moire detection result in block S330, the first number V1 and the second number V2 may be compared to each other.

As a result of the comparison, when the first number V1 is less than the second number V2, decreasing the size of the lens width in block S340 may be performed. After decreasing the size of the lens width (e.g., decreasing by a predetermined size), obtaining the first number V1, which is the number of moires at the first viewing distance in block S310, may be performed again.

As a result of the comparison, when the first number V1 is greater than the second number V2, increasing the size of the lens width in block S350 may be performed. After increasing the size of lens width (e.g., increasing by a predetermined size), obtaining the first number V1, which is the number of moires at the first viewing distance in block S310, may be performed again.

As a result of the comparison, when the first number V1 and the second number V2 are the same, providing the size of the lens width as the parameter in block S360 may be performed. In the above step, both of the first number V1 and the second number V2 may be the same as 0.

According to the parameter determination method 300 according to an embodiment of the present disclosure, a parameter for the size of the lens width may be provided.

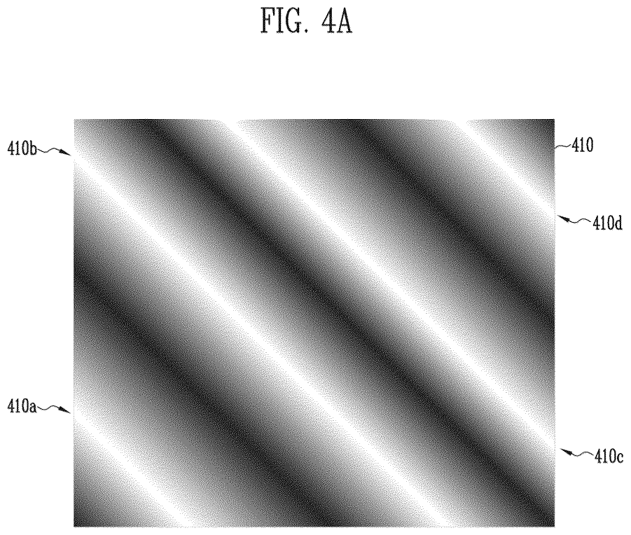

FIG. 4A is an example of an image 410 in which more moire is detected. FIG. 4B is an example of an image 420 in which less moire is detected.

When moire occurs, a wave pattern may be observed in an image. The number of valleys or ridges of the wave pattern appearing in an image may correspond to the number of moires detected in the image.

Referring to FIG. 4A, four moires 410a, 410b, 410c, and 410d are detected in the image 410.

Referring to FIG. 4B, two moires 420a and 420b are detected in the image 420.

Referring to FIG. 3 described above, when the image 410 of FIG. 4A corresponds to an image captured at the first viewing distance and the image 420 of FIG. 4B corresponds to an image captured at the second viewing distance, the first number V1 is four, and the second number V2 is two. In the above case, since the first number V1 is greater than the second number V2, increasing the size of the lens width in block S350 may be performed.

In contrast, when the image 420 of FIG. 4B corresponds to an image captured at the first viewing distance and the image 410 of FIG. 4A corresponds to an image captured at the second viewing distance, the first number V1 is two, and the second number V2 is four. In the above case, since the first number V1 is less than the second number V2, decreasing the size of the lens width in block S340 may be performed.

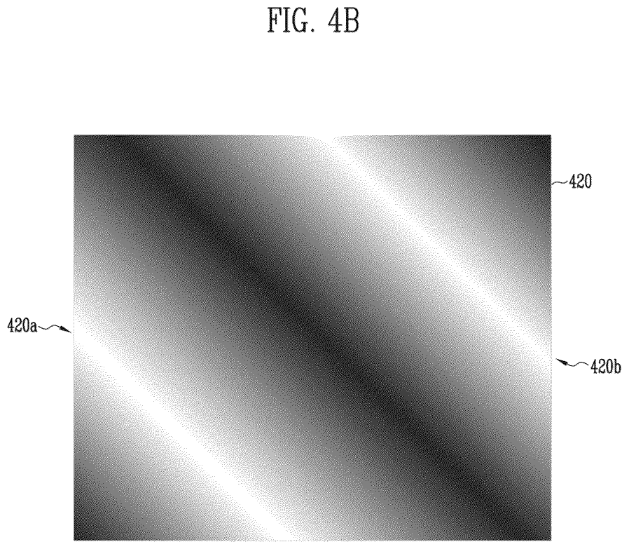

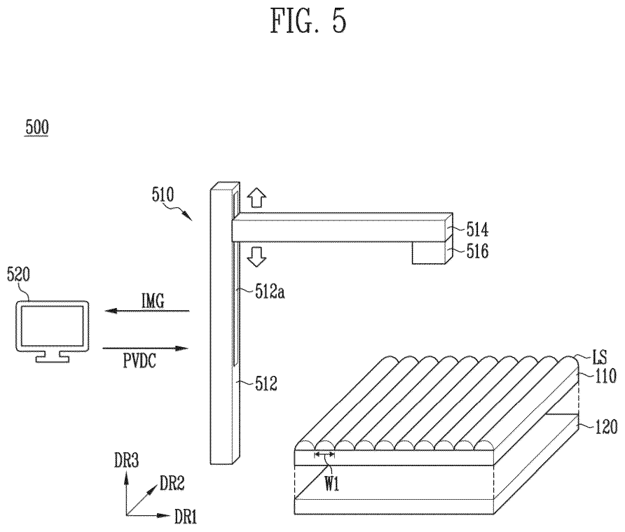

FIGS. 5 and 6 are a parameter determination system 500 according to embodiments of the present disclosure.

Referring to FIGS. 5 and 6, the parameter determination system 500 according to embodiments of the present disclosure may include an optical panel 110, a display panel 120, a panel viewing distance controller 510, and a controller 520.

The optical panel 110 may include a plurality of variable lenses LS. Each of the plurality of variable lenses LS may have a predetermined lens width. Referring to FIG. 5, a size of the lens width may be a first size W1. Referring to FIG. 6, a size of the lens width may be a second size W2 which may be greater than the first size W1. In embodiments shown in FIGS. 5-6, the plurality of variable lenses LS extend longitudinally in the second direction DR2. However, embodiments of the present disclosure are not necessarily limited thereto.

The display panel 120 may be disposed to be spaced apart from the optical panel 110 in the third direction DR3. Light emitted from the display panel 120 may be refracted through the optical panel 110 and emitted to the outside.

The panel viewing distance controller 510 is configured to capture (e.g., image) the optical panel 110 on the display panel 120. In an embodiment, the panel viewing distance controller 510 may include a first vertical support 512, a first horizontal support 514, and a camera 516 (e.g., an imaging device).

The first vertical support 512 may be disposed to extend in the third direction DR3 from a ground. For example, the third direction DR3 may be a direction perpendicular to the ground. In an embodiment, the first vertical support 512 may be positioned adjacent to the display panel 120 and the optical panel 110 in one direction (e.g., the first direction DR1).

In an embodiment, the first horizontal support 514 may extend longitudinally from the first vertical support 512 in one direction (e.g., a horizontal direction, such as the first direction DR1). The first horizontal support 514 may move in a vertical direction (e.g., the third direction DR3 and a direction opposite thereto) along the first vertical support 512. In an embodiment, the first vertical support 512 may include a first rail 512a configured to guide a movement of the first horizontal support 514 in the vertical direction (e.g., the third direction DR3).

The camera 516 (e.g., an imaging device) may be mounted on the first horizontal support 514. The camera 516 may capture (e.g., image) the optical panel 110. For example, the camera 516 may capture the image from the light emitted from the display panel 120 and refracted through the optical panel 110. An image IMG captured by the camera 516 photographing the optical panel 110 may be transmitted to the controller 520.

In an embodiment, the controller 520 may output a panel viewing distance control signal PVDC for controlling a vertical direction movement (e.g., movement in the third direction DR3) of the first horizontal support 514. The first horizontal support 514 may move to a position corresponding to the panel viewing distance control signal PVDC in response to the panel viewing distance control signal PVDC. The controller 520 may receive the image IMG from the camera 516.

In an embodiment, the controller 520 may receive at least four images IMG from the camera 516.

The controller 520 may receive an image captured by the camera 516 at the first viewing distance when the size of the lens width is a first size W1.

The controller 520 may receive an image captured by the camera 516 at the second viewing distance when the size of the lens width is the first size W1.

The controller 520 may receive an image captured by the camera 516 at the first viewing distance when the size of the lens width is a second size W2.

The controller 520 may receive an image captured by the camera 516 at the second viewing distance when the size of the lens width is the second size W2.

The controller 520 may determine the size of the lens width at which the number of moire is decreased based on comparing the number of moires in the obtained images IMG.

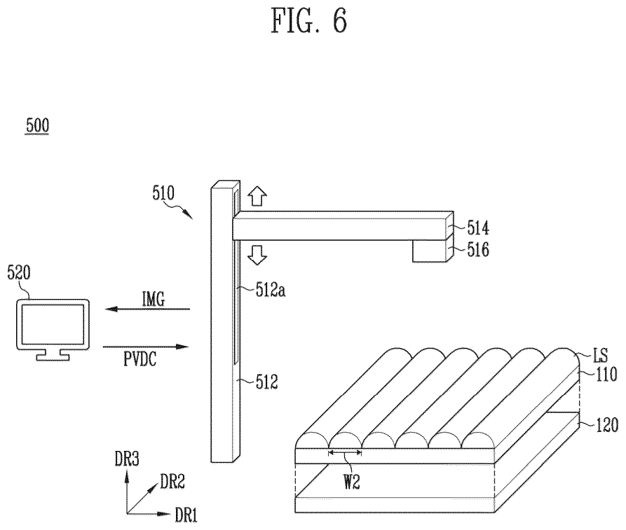

FIGS. 7A and 7B are diagrams illustrating an embodiment in which the width of the plurality of variable lenses LS is adjusted in the optical panel 110.

Referring to FIG. 7A, the optical panel 110 may include the plurality of variable lenses LS and a base substrate BS supporting the plurality of variable lenses LS.

In an embodiment, the base substrate BS may be a light-transmissive (e.g., a transparent) substrate. The base substrate BS may be a rigid substrate or a flexible substrate. The base substrate BS may include plastic or glass. However, embodiments of the present disclosure are not necessarily limited thereto.

In an embodiment, the plurality of variable lenses LS may include a light-transmissive (e.g., transparent) fluid, such as a light-transmissive liquid. For example, the plurality of variable lenses LS may include resin RSN. For example, the resin RSN may be in an uncured liquid state. However, embodiments of the present disclosure are not necessarily limited thereto.

In an embodiment, the optical panel 110 may further include an electromagnet unit 700. For example, the electromagnet unit 700 may include a first magnet unit 710 and a second magnet unit 720. The first magnet unit 710 is positioned on the base substrate BS, and the second magnet unit 720 is positioned inside the plurality of variable lenses LS.

At least one of the first magnet unit 710 and the second magnet unit 720 may be implemented as an electromagnet.

In an embodiment, both of the first magnet unit 710 and the second magnet unit 720 may be implemented as electromagnets, and the polarities of the electromagnets may be different from each other. In an embodiment, one of the first magnet unit 710 and the second magnet unit 720 may be implemented as a permanent magnet, and the other may be implemented as an electromagnet. In an embodiment, one of the first magnet unit 710 and the second magnet unit 720 may be implemented as an electromagnet, and the other may be implemented as a metal attached to a magnet. For example, in an embodiment, the metal may be iron (Fe), nickel (Ni), cobalt (Co), or the like. However, embodiments of the present disclosure are not necessarily limited thereto.

In an embodiment, by electrically controlling the electromagnet unit 700, the first magnet unit 710 and the second magnet unit 720 may be attached to each other or separated from each other. Accordingly, the width of the variable lens LS may be adaptively controlled.

Referring to FIG. 7A, a case where the first magnet unit 710 and the second magnet unit 720 are separated from each other is shown. In the above case, the size of the lens width of the variable lens LS may be relatively large.

Referring to FIG. 7B, a case where the first magnet unit 710 and the second magnet unit 720 are attached to each other (e.g., in direct contact with each other) is shown. In the above case, the size of the lens width of the variable lens LS may be relatively small.

Referring to FIGS. 7A and 7B, an embodiment in which one electromagnet unit 700 is disposed in correspondence with each of the plurality of variable lenses LS is shown. However, embodiments of the present disclosure are not necessarily limited thereto. For example, in some embodiments, two or more electromagnet units 700 may be disposed in correspondence with one variable lens LS.

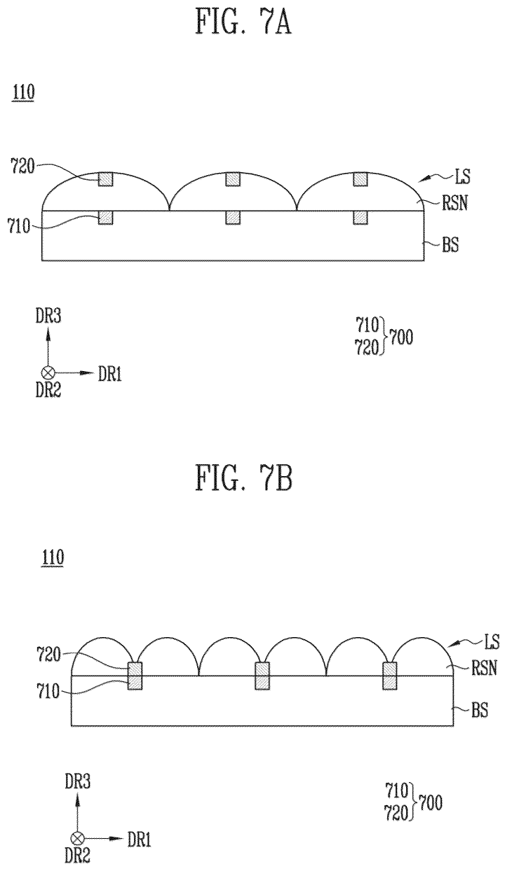

FIG. 8 is a diagram illustrating the controller 520 transmitting an electromagnet control signal to the optical panel 110.

Referring to FIG. 8, the controller 520 according to an embodiment of the present disclosure may output an electromagnet control signal ECS. The optical panel 110 may provide a voltage to an internal electromagnet based on the electromagnet control signal ECS to impart magnetism or remove magnetism to the internal electromagnet.

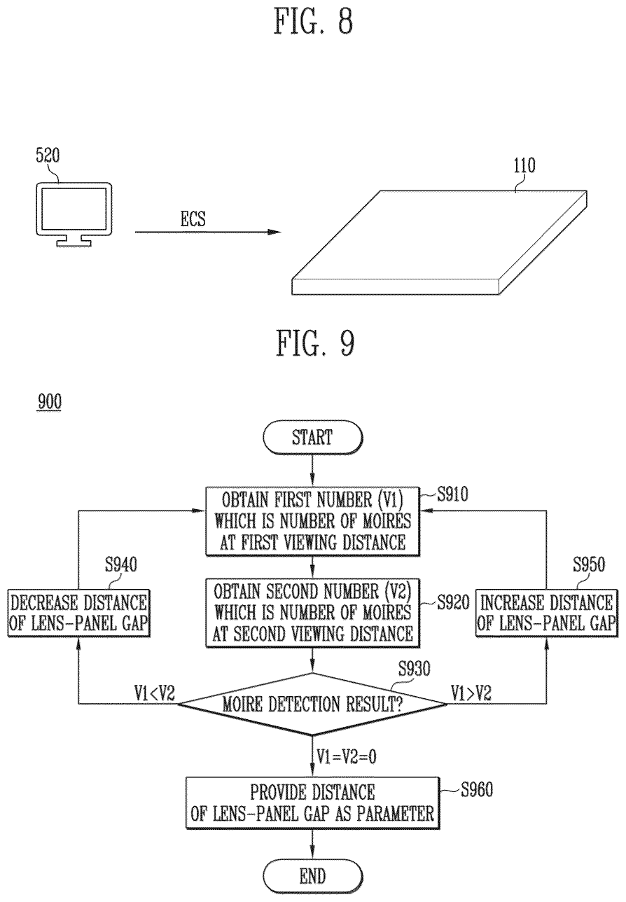

FIG. 9 is a flowchart of a parameter determination method 900 according to an embodiment of the present disclosure.

Referring to FIG. 9, the parameter determination method 900 according to an embodiment of the present disclosure may include obtaining the first number V1, which is the number of moires at a first viewing distance in block S910, obtaining the second number V2, which is the number of moires at a second viewing distance in block S920, determining a moire detection result in block S930, decreasing a distance of the lens-panel gap in block S940, increasing the distance of the lens-panel gap in block S950, and providing the distance of the lens-panel gap as a parameter in block S960.

In an embodiment, in obtaining the first number V1, which is the number of moires at the first viewing distance in block S910, the panel viewing distance PVD (refer to FIG. 2) may be the first viewing distance. The first number V1 may be an integer greater than or equal to 0.

In obtaining the second number V2, which is the number of moires at the second viewing distance in block S920, the panel viewing distance PVD (refer to FIG. 2) may be the second viewing distance. In an embodiment, the second viewing distance may be greater than the first viewing distance. The second number V2 may be an integer greater than or equal to 0.

In determining the moire detection result in block S930, the first number V1 and the second number V2 may be compared to each other.

As a result of the comparison, when the first number V1 is less than the second number V2, decreasing the distance of the lens-panel gap in block S940 may be performed. After decreasing the distance of the lens-panel gap (e.g., decreasing by a predetermined distance), obtaining the first number V1, which is the number of moires at the first viewing distance in block S910, may be performed again.

As a result of the comparison, when the first number V1 is greater than the second number V2, increasing the distance of the lens-panel gap in block S950 may be performed. After increasing the distance of the lens-panel gap (e.g., increasing by a predetermined distance), obtaining the first number V1, which is the number of moires at the first viewing distance in block S910, may be performed again.

As a result of the comparison, when the first number V1 and the second number V2 are the same, providing the distance of the lens-panel gap as the parameter in block S960 may be performed. In the above step, both of the first number V1 and the second number V2 may be 0.

In the parameter determination method 900 according to an embodiment of the present disclosure, a parameter for the distance of the lens-panel gap may be provided.

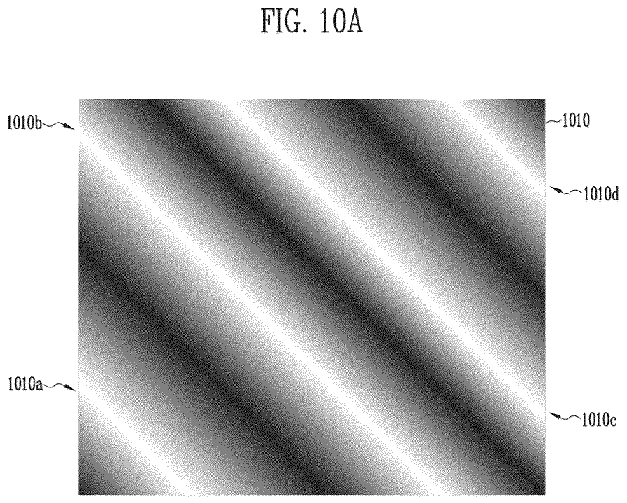

FIG. 10A is an example of an image in which more moire is detected. FIG. 10B is an example of an image in which less moire is detected.

Referring to FIG. 10A, four moires 1010a, 1010b, 1010c, and 1010d are detected in the image 1010.

Referring to FIG. 10B, two moires 1020a and 1020b are detected in the image 1020.

Referring to FIG. 9 described above, when the image 1010 of FIG. 10A corresponds to an image captured at the first viewing distance and the image 1020 of FIG. 10B corresponds to an image captured at the second viewing distance, the first number V1 is four, and the second number V2 is two. In the above case, since the first number V1 is greater than the second number V2, increasing the distance of the lens-panel gap in block S950 may be performed.

In contrast, when the image 1020 of FIG. 10B corresponds to an image captured at the first viewing distance and the image 1010 of FIG. 10A corresponds to an image captured at the second viewing distance, the first number V1 is two, and the second number V2 is four. In the above case, since the first number V1 is less than the second number V2, decreasing the distance of the lens-panel gap in block S940 may be performed.

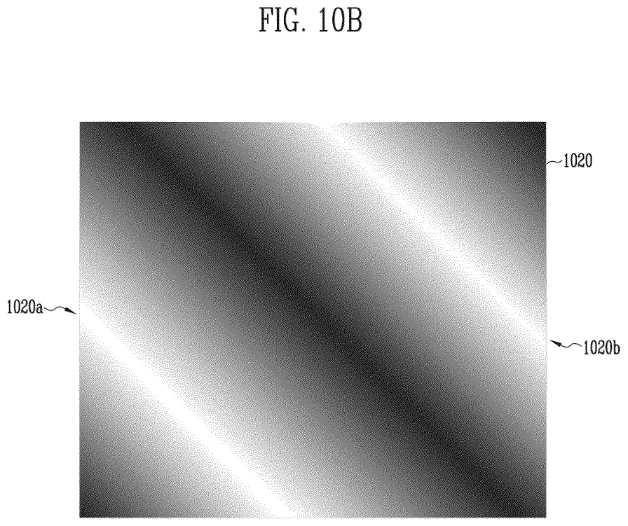

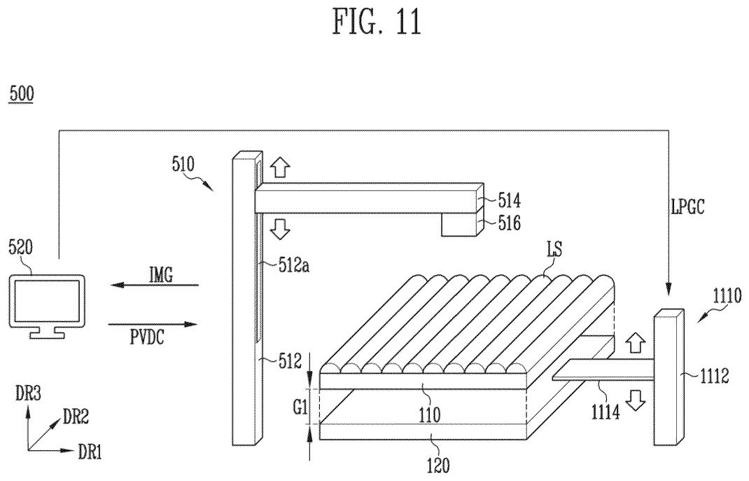

FIGS. 11 and 12 are a parameter determination system 500 according to embodiments of the present disclosure.

Referring to FIGS. 11 and 12, the parameter determination system 500 according to embodiments of the present disclosure may include an optical panel 110, a display panel 120, a panel viewing distance controller 510, a controller 520, and a lens-panel gap controller 1110.

A description of the optical panel 110, the display panel 120, and the panel viewing distance controller 510 are the same as that described above with reference to FIGS. 5 and 6, and thus a description thereof is omitted for economy of description.

The lens-panel gap controller 1110 may be configured to adjust the lens-panel gap LPG (refer to FIG. 2) between the optical panel 110 and the display panel 120. In an embodiment, the lens-panel gap controller 1110 may include a second vertical support 1112 and a second horizontal support 1114.

In an embodiment, the second vertical support 1112 may be positioned adjacent to the optical panel 110 and/or the display panel 120 in one direction (e.g., the first direction DR1). However, embodiments of the present disclosure are not necessarily limited thereto. The second vertical support 1112 may extend in one direction (e.g., the third direction DR3) from the ground.

The second horizontal support 1114 may be connected to the second vertical support 1112 and may move in a vertical direction (e.g., the third direction DR3). The second horizontal support 1114 may be attached to at least one of the optical panel 110 and the display panel 120 to increase or decrease the lens-panel gap between the optical panel 110 and the display panel 120. For example, as shown in an embodiment of FIG. 11, the second horizontal support 1114 may be attached to (e.g., directly attached thereto) the display panel 120 to increase or decrease a distance between the optical panel 110 and the display panel 120. The second horizontal support 1114 may increase or decrease the distance between the optical panel 110 and the display panel 120 in response to a lens-panel gap control signal LPGC.

In an embodiment, the second vertical support 1112 may further include a second rail configured to guide a movement of the second horizontal support 1114 in the vertical direction (e.g., in the third direction DR3).

The controller 520 may output the lens-panel gap control signal LPGC for controlling a movement of the second horizontal support 1114 in the vertical direction. The second horizontal support 1114 may move to a position corresponding to the lens-panel gap control signal LPGC in response to the lens-panel gap control signal LPGC. The controller 520 may receive an image IMG from the camera 516.

In an embodiment, the controller 520 may receive at least four images IMG from the camera 516.

The controller 520 may receive an image captured by the camera 516 at the first viewing distance when the distance of the lens-panel gap is a first distance G1.

The controller 520 may receive an image captured by the camera 516 at the second viewing distance when the lens-panel gap distance is the first distance G1.

The controller 520 may receive an image captured by the camera 516 at the first viewing distance when the lens-panel gap distance is a second distance G2. The second distance G2 may be different from the first distance G1. For example, in an embodiment the second distance G2 may be greater than the first distance G1.

The controller 520 may receive an image captured by the camera 516 at the second viewing distance when the distance of the lens-panel gap is the second distance G2.

The controller 520 may determine the distance of the lens-panel gap at which the number of moire is decreased based on the obtained images IMG.

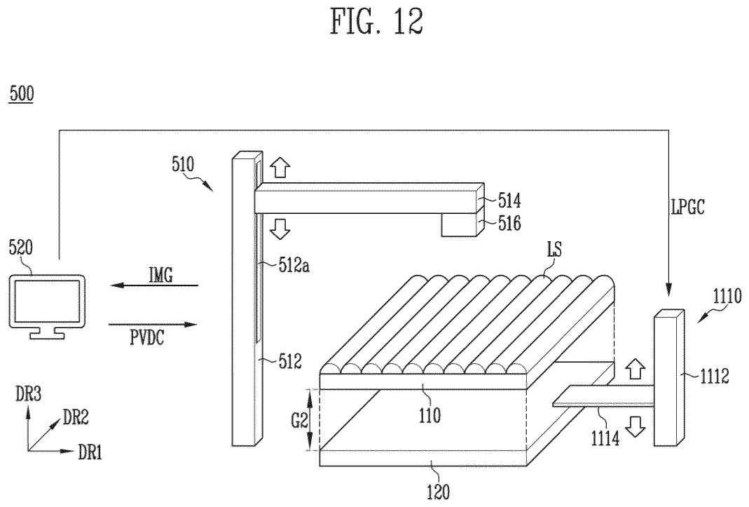

FIGS. 13 to 15 are diagrams conceptually describing that an area from which light is emitted varies according to a lens-panel gap and a thickness of a lens in embodiments of the present disclosure.

Referring to FIGS. 13 to 15, in an embodiment light may be emitted by passing through the display panel 120, an air layer AIR, and the optical panel 110. The display panel 120 may correspond to an area on a light emitting element. The optical panel 110 may correspond to a thickness of the variable lens LS. The air layer AIR may correspond to the distance of the lens-panel gap LPG.

Referring further to FIGS. 7A and 7B described above, a decrease in the thickness of the variable lens LS may correspond to a decrease in the width of the variable lens LS. An increase in the thickness of the variable lens LS may correspond to an increase in the width of the variable lens LS.

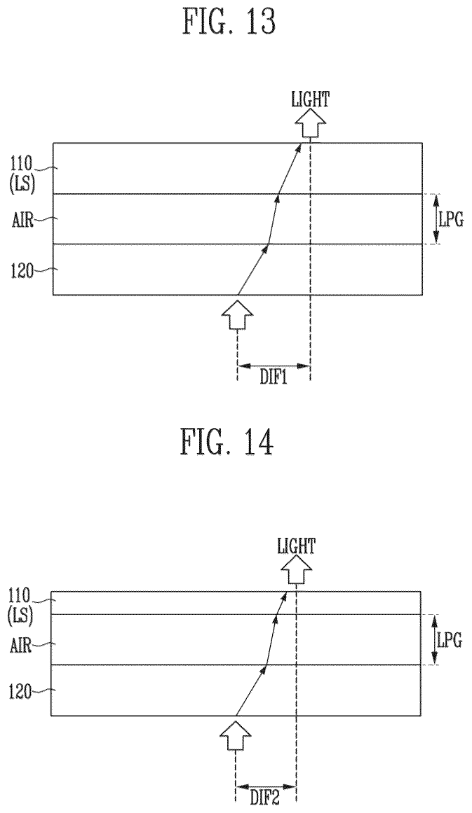

Comparing FIGS. 13 and 14, when a thickness of the optical panel 110 decreases (e.g., the thickness of the variable lens LS decreases), a difference between an area where light is incident and an area where light is emitted may decrease from a first difference DIF1 to a second difference DIF2.

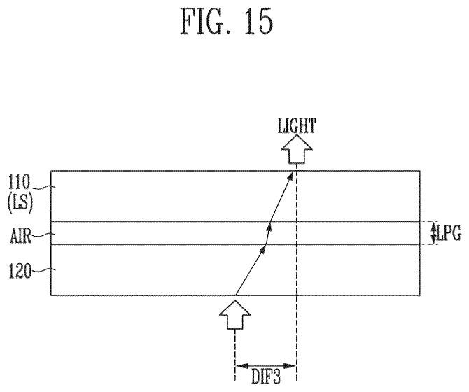

Comparing FIGS. 13 and 15, when the distance of the lens-panel gap LPG decreases (e.g., a thickness of the air layer AIR decreases), the difference between the area where light is incident and the area where light is emitted may decrease from the first difference DIF1 to a third difference DIF3.

Accordingly, a parameter that may alleviate or eliminate a phenomenon in which moire is recognized to the user may be provided by adaptively varying the difference between the area where light is incident and the area where light is emitted according to a position. The above-described parameter may be the lens width of the variable lens LS. The above-described parameter may be a lens-panel gap LPG corresponding to the distance between the optical panel 110 and the display panel 120.

According to the parameter determination system and the parameter determination method of the parameter determination system according to embodiments of the present disclosure, a parameter that may alleviate or prevent moire from being recognized may be provided.

The drawings referred to so far and the detailed description of non- limiting embodiments of the present disclosure described herein are merely examples of embodiments the present disclosure, are used for merely describing the present disclosure, and are not intended to limit the meaning and the scope of the present disclosure. Therefore, those skilled in the art will understand that various modifications and equivalents are possible from the described embodiments.

What is claimed is:

1. A parameter determination system comprising:
an optical panel including a plurality of variable lenses;
a display panel positioned to overlap with the optical panel and spaced apart from the optical panel by a lens-panel gap, the display panel including a plurality of sub-pixels;
a panel viewing distance controller adjusting a viewing distance between the optical panel and an imaging device capturing the optical panel; and
a controller outputting a signal for adjusting at least one of a size of a lens width of the plurality of variable lenses and a distance of the lens-panel gap, based on images of the optical panel captured by the imaging device at different viewing distances.

2. The parameter determination system according to claim 1, wherein the controller outputs the signal so that a number of moires detected in the images is decreased.

3. The parameter determination system according to claim 1, wherein the optical panel further comprises:
a base substrate supporting the plurality of variable lenses;
a first magnet unit positioned inside the plurality of variable lenses; and
a second magnet unit positioned on the base substrate.

4. The parameter determination system according to claim 3, wherein:
at least one of the first magnet unit and the second magnet unit is an electromagnet; and
the controller outputs an electromagnet control signal for imparting magnetism to the at least one of the first magnet unit and the second magnet unit or removing magnetism from the at least one of the first magnet unit and the second magnet unit.

5. The parameter determination system according to claim 4, wherein a width of each of the plurality of variable lenses is controlled based on the electromagnet control signal.

6. The parameter determination system according to claim 1, wherein the panel viewing distance controller comprises:
the imaging device comprising a camera;
a first vertical support extending in a vertical direction from a ground; and
a first horizontal support extending from the first vertical support in a horizontal direction on the optical panel, the camera is mounted on the first horizontal support,
wherein the first horizontal support moves in the vertical direction along the first vertical support.

7. The parameter determination system according to claim 6, wherein the first vertical support further comprises a first rail guiding movement of the first horizontal support in the vertical direction.

8. The parameter determination system according to claim 1, further comprising:
a lens-panel gap controller controlling a distance of the lens-panel gap between the optical panel and the display panel.

9. The parameter determination system according to claim 8, wherein the lens-panel gap controller comprises:
a second vertical support extending in a vertical direction from a ground;
a second horizontal support extending from the second vertical support in a horizontal direction, the display panel is attached to the second horizontal support, and
wherein the second horizontal support moves in the vertical direction along the second vertical support.

10. The parameter determination system according to claim 9, wherein the second vertical support further comprises a second rail guiding movement of the second horizontal support in the vertical direction.

11. The parameter determination system according to claim 1, wherein:
the controller compares a first number comprising a number of moires detected in an image captured at a first viewing distance with a second number comprising a number of moires detected in an image captured at a second viewing distance farther than the first viewing distance; and
the controller outputs a signal for adjusting at least one of a size of the lens width and a distance of the lens-panel gap based on a comparison result of the first number with the second number.

12. The parameter determination system according to claim 11, wherein the controller detects the number of moires in the image captured at the first viewing distance, and detects the number of moires in the image captured at the second viewing distance farther than the first viewing distance.

13. The parameter determination system according to claim 12, wherein when the first number is less than the second number, the controller decreases the size of the lens width, and when the first number is greater than the second number, the controller increases the size of the lens width.

14. The parameter determination system according to claim 13, wherein the controller provides at least one of a size of the lens width and a size of the lens-panel gap as a parameter when both the first number and the second number are 0.

15. The parameter determination system according to claim 12, wherein when the first number is less than the second number, the controller decreases the distance of the lens-panel gap, and when the first number is greater than the second number, the controller increases the distance of the lens-panel gap.

16. A parameter determination method comprising:
capturing an optical panel that includes a plurality of variable lenses at a first viewing distance by a camera of a panel viewing distance controller, wherein the optical panel is spaced apart from a display panel by a lens-panel gap of a predetermined distance;
obtaining a first number that is a number of moires in an image of the optical panel captured by the camera at the first viewing distance;
capturing the optical panel by the camera at a second viewing distance that is less than the first viewing distance;
obtaining a second number that is a number of moires in an image of the optical panel captured by the camera at the second viewing distance; and
outputting a signal for adjusting at least one of a size of a lens width of the plurality of variable lenses and a distance of the lens-panel gap so that a number of moires is decreased based on a result of comparing the first number and the second number by a controller.

17. The parameter determination method according to claim 16, wherein:
when the first number is less than the second number, the controller decreases the size of the lens width; and
when the first number is greater than the second number, the controller increases the size of the lens width.

18. The parameter determination method according to claim 17, wherein the controller provides the size of the lens width as a parameter when both the first number and the second number are 0.

19. The parameter determination method according to claim 16, wherein:
when the first number is less than the second number, the controller decreases the distance of the lens-panel gap; and
when the first number is greater than the second number, the controller increases the distance of the lens-panel gap.

20. The parameter determination method according to claim 19, wherein the controller provides the distance of the lens-panel gap as a parameter when both of the first number and the second number are 0.
